(19) United States
(12) Patent Application Publication
(10) Pub. No.: US 2012/0025413 A1
(43) Pub. Date: Feb. 2, 2012

(54) METHOD OF MANUFACTURING GRAPHENE

(75) Inventors: Seung-min CHO, Changwon-city (KR); Dong-kwan WON, Changwon-city (KR); Se-hoon CHO, Changwon-city (KR)

(73) Assignee: SAMSUNG TECHWIN CO., LTD., Changwon-city (KR)

(21) Appl. No.: 13/191,897

(22) Filed: Jul. 27, 2011

(30) Foreign Application Priority Data
Jul. 27, 2010 (KR) 10-2010-0072486

(51) Int. Cl. B29C 39/14

(52) U.S. Cl. 264/166; 425/66

(57) ABSTRACT

Provided are a method and apparatus of manufacturing high quality large area graphene in large quantities. The method includes placing a supporting belt, on which a catalyst layer is loaded, into a chamber; increasing a temperature of the catalyst layer by injecting a carbon source into the chamber; forming graphene on the catalyst layer by cooling the catalyst layer; and taking out the supporting belt, on which the catalyst layer, on which the graphene is formed, is loaded, from the chamber to an outside, wherein a ratio between a melting point of the supporting belt and a maximum temperature Tmax of the catalyst metal layer that the catalyst layer is heated in the chamber is equal to or less than 0.6.

### CROSS-REFERENCE TO RELATED PATENT APPLICATION

This application claims priority from Korean Patent Application No. 10-2010-0072486, filed on Jul. 27, 2010, in the Korean Intellectual Property Office, the disclosure of which is incorporated herein in its entirety by reference.

### BACKGROUND

1. Field

Methods and apparatuses consistent with exemplary embodiments relate to manufacturing graphene.

2. Description of the Related Art

Currently, materials based on carbon, for example, carbon nanotubes, diamond, graphite, and graphene have been studied in various nano technology fields. Such materials are currently being used or will be used in field effect transistors (FETs), biosensors, nano composites, or quantum devices.

Graphene is a two-dimensional semiconductor material having a zero band gap. In recent years, various research results have been reported with respect to electrical characteristics of graphene. The electrical characteristics of graphene include a bipolar supercurrent, spin transport, and a quantum hole effect. Currently, graphene is receiving attention as a material to be used as a basic unit for integration of carbon based nano electronic devices.

As interest in graphene increases, there is a need to develop a method of producing high quality graphene in large quantities.

### SUMMARY

One or more exemplary embodiments provide a method of manufacturing high quality and large area graphene in large quantities and an apparatus therefor.

According to an aspect of an exemplary embodiment, there is provided a method of manufacturing graphene, the method including: placing a supporting belt, on which a catalyst layer is loaded, into a chamber; increasing a temperature of the catalyst layer by injecting a carbon source into the chamber; forming graphene on the catalyst layer by cooling the catalyst layer; and taking out the supporting belt, on which the catalyst layer, on which the graphene is formed, is loaded, from the chamber to an outside, wherein a ratio of a melting point Tmp of the supporting belt to a maximum temperature Tmax of the catalyst metal layer may be equal to or less than 0.6.

The method may include performing a reel-to-reel method.

The supporting belt may include at least one of zirconium (Zr), chromium (Cr), vanadium (V), rhodium (Rh), technetium (Tc), hafnium (Hf), ruthenium (Ru), boron (B), iridium (Ir), niobium (Nb), molybdenum (Mo), tantalum (Ta), osmium (Os), rhenium (Re), and tungsten (W).

The placing the supporting belt, on which the catalyst layer is loaded, into the chamber may include conveying a portion of the supporting belt, on which a portion of the catalyst layer is loaded, into the chamber; separating the portion of the supporting belt from the portion of the catalyst layer after taking out the portion of the supporting layer, on which the portion of the catalyst layer is loaded, from the chamber; and conveying the portion of the supporting belt, on which another portion of the catalyst layer is loaded, into the chamber.

The method may further include separating the supporting belt from the catalyst layer on which the graphene is formed.

The method may further include removing the catalyst layer from the catalyst layer on which the graphene is formed after the forming the graphene.

The removing the catalyst layer may include removing the catalyst layer by etching the catalyst layer.

The method may further include forming a graphene protection film on the graphene between the forming of the graphene and the removing the catalyst layer.

The chamber may be maintained at a pressure in a range from 10⁻³ to 10⁻² torr.

According to an aspect of another exemplary embodiment, there is provided an apparatus for manufacturing graphene, the apparatus including a supporting belt provider which loads a catalyst layer on a supporting belt and provides the supporting belt on which the catalyst layer is loaded; and a chamber which receives the supporting belt, on which the catalyst layer is loaded, provided from the supporting belt, increases a temperature of the catalyst layer while receiving a carbon source from an outside, forms graphene on the catalyst layer by cooling the catalyst layer, and outputs the supporting belt on which the catalyst layer, on which the graphene is formed, is loaded.

In the apparatus, a ratio of a melting point of the supporting belt to a maximum temperature of the catalyst layer that the catalyst layer is heated in the chamber may be equal to or less than 0.6.

In providing the supporting belt on which the catalyst layer is loaded to the chamber, the supporting belt provider may: convey a portion of the supporting belt, on which a portion of the catalyst layer is loaded, into the chamber; separate the portion of the supporting belt from the portion of the catalyst layer after taking out the portion of the supporting layer, on which the portion of the catalyst layer is loaded, from the chamber; and convey the portion of the supporting belt, on which another portion of the catalyst layer is loaded, into the chamber.

The supporting belt may include at least one of zirconium Zr, chromium Cr, vanadium V, rhodium Rh, technetium Tc, hafnium Hf, ruthenium Ru, boron B, iridium Ir, niobium Nb, molybdenum Mo, tantalum Ta, osmium Os, rhenium Re, and tungsten W.

The chamber may be maintained at a pressure in a range from 10⁻³ to 10⁻² torr.

A plurality of the catalyst metal layers having a panel shape may be conveyed into the chamber by the supporting belt.

According to the exemplary embodiments, high quality graphene may be produced in large quantities.

### BRIEF DESCRIPTION OF THE DRAWINGS

The above and other features aspects will become more apparent by describing in detail exemplary embodiments with reference to the attached drawings, in which:

FIG. 1 is a flowchart schematically showing a method of manufacturing graphene according to an exemplary embodiment;

FIG. 2 is a schematic drawing showing a process system of the method of manufacturing graphene of FIG. 1, according to an exemplary embodiment;

FIG. 3 is a graph showing a change in strength of a metal according to variations in temperature, according to an exemplary embodiment;

FIG. 4 is a schematic lateral cross-sectional view of a catalyst metal layer transported according to an operation of conveying a catalyst metal layer of FIG. 1, according to an exemplary embodiment;

FIG. 5 is a schematic lateral cross-sectional view of graphene formed on a catalyst metal layer according to operations of injecting a gaseous carbon source, forming graphene, and taking out the catalyst metal layer of FIG. 1, according to an exemplary embodiment;

FIG. 6 is a schematic lateral cross-sectional view of a graphene protection film formed according to an operation of forming the graphene protection film of FIG. 1, according to an exemplary embodiment; and

FIG. 7 is a schematic lateral cross-sectional view of graphene from which a catalyst metal layer is removed according to an operation of removing the catalyst metal layer of FIG. 1, according to an exemplary embodiment.

### DETAILED DESCRIPTION OF EXEMPLARY EMBODIMENTS

Exemplary embodiments will now be described more fully with reference to the accompanying drawings. The exemplary embodiments may, however, be changed or modified in many different forms and should not be construed as being limited thereto; rather, these exemplary embodiments are provided so that this disclosure will be thorough and complete, and will fully convey the inventive concept to those of ordinary skill in the art and the scope of the inventive concept is defined by the appended claims. The terminology used herein is for the purpose of describing particular exemplary embodiments only and is not intended to be limiting the inventive concept. In the current specification, the singular forms include the plural forms unless the context clearly indicates otherwise. It will be further understood that the terms “comprise” and/or “comprising,” when used in this specification, specify the presence of stated features, steps, operations, elements, and/or components, but do not preclude the presence or addition of one or more other features, steps, operations, elements, and/or components. It will be understood that, although the terms first, second, etc., may be used herein to describe various constituent elements, these constituent elements should not be limited by these terms. These terms are only used to distinguish one constituent element from another constituent element.

A catalyst metal layer used in the current specification may be only one single layer. Alternatively, the catalyst metal layer may be a layer formed on the outermost layer of a specific substrate having a plurality of layers. That is, the catalyst metal layer denotes one single layer or the outermost layer of a plurality of layers.

Hereinafter, for convenience of explanation, one single catalyst metal layer is described.

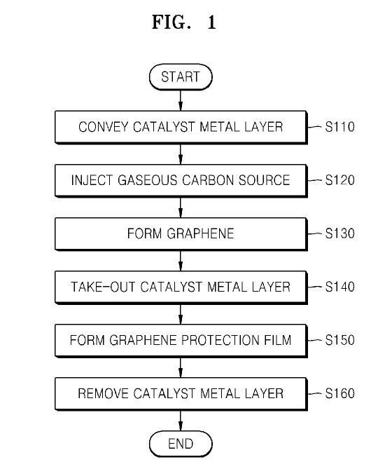

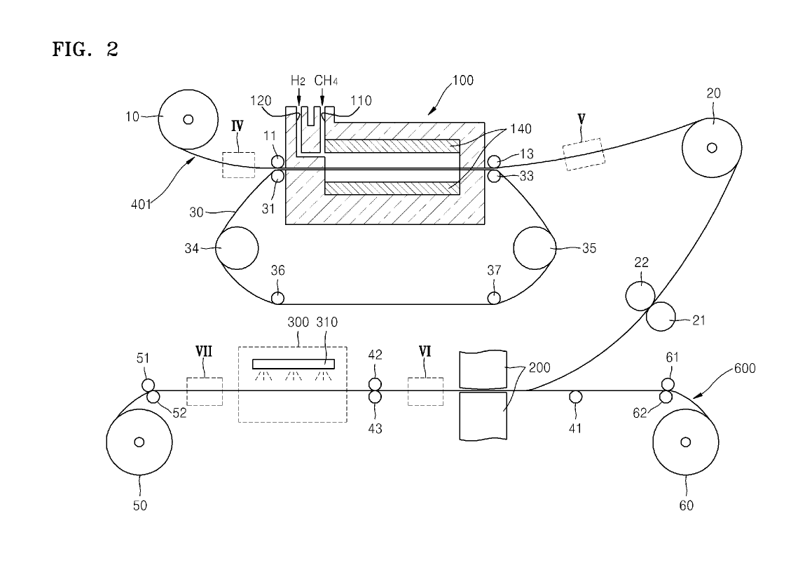

FIG. 1 is a flowchart schematically showing a method of manufacturing graphene according to an exemplary embodiment. FIG. 2 is a schematic drawing showing a process system of the method of manufacturing graphene of FIG. 1, according to an exemplary embodiment. As depicted in FIG. 2, the method of manufacturing graphene may be performed by a reel-to-reel method.

In operation S110, a supporting belt 30 on which a catalyst metal layer 401 is loaded enters into a chamber 100. That is, the catalyst metal layer 401 is conveyed into the chamber 100 by the supporting belt 30. Referring to FIG. 2 and FIG. 4, the catalyst metal layer 401 is supplied by a reel 10, rollers 11 and 13.

The catalyst metal layer 401 may be formed of at least one of copper (Cu) and nickel (Ni).

Since the temperature of the chamber 100 is maintained at a high temperature, the mechanical strength of the catalyst metal layer 401 is reduced in the chamber 100, and thus, the catalyst metal layer 401 is weakened by its own weight (i.e., self-weight). As a comparative embodiment, if a single layer of the catalyst metal layer 401 is introduced into the chamber 100, high quality graphene may not be formed due to non-elastic deformation of the catalyst metal layer 401. However, the supporting belt 30 disposed under the catalyst metal layer 401 prevents strength reduction of the catalyst metal layer 401 and prevents quality reduction of graphene 402 due to the strength reduction of the catalyst metal layer 401. The catalyst metal layer 401 and the graphene 402 produced accordingly will be described in relation to operations S120 through S140.

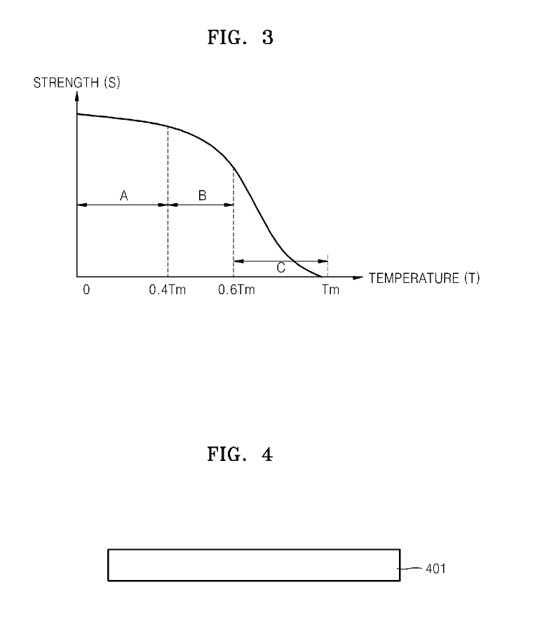

FIG. 3 is a graph showing a change in strength S of a metal according to variations in temperature T. In FIG. 3, Tm denotes a melting point of the metal. Section A is a region where the strength of the metal is barely affected by temperature. Section B is a region where the strength of the metal begins to be affected by temperature, and thus, the deformation rate of the metal is evidently increased. Section C is a region where the metal becomes weak due to its self-weight, and thus, the mechanical strength of the metal is rapidly reduced.

Therefore, in order to support the catalyst metal layer 401 in the chamber 100 in terms of strength, the supporting belt 30 having a homologous temperature T_{H}, that is, the supporting belt 30 formed of a material having a ratio of a maximum temperature Tmax of the catalyst metal layer 401 to a melting point Tmp of the supporting belt 30 being equal to or less than 0.6, is used. In other words, the supporting belt 30 formed of a material having 0.6Tmp that is equal to or greater than Tmax is used. This relationship may be expressed as shown in Equation 1.

$$Th = \frac{Tmax}{Tmp} \leq 0.6 or 0.6 Tmp \geq Tmax \qquad [ Equation 1 ]$$

According to the current exemplary embodiment, the temperature Tc of the chamber 100 forms an equilibrium with the temperature of the catalyst metal layer 401 after a predetermined period of time. Accordingly, the temperature Tc of the chamber 100 is increased to increase the temperature of the catalyst metal layer 401. For example, since the temperature of the chamber 100 is approximately 1,000° C., a melting point of the supporting belt 30 that satisfies Equation 1 must be greater than approximately 1,667° C. Preferably but not necessarily, the melting point of the supporting belt 30 may be greater than about 1,850° C. A material that satisfies this condition may be at least one of zirconium (Zr), chromium (Cr), vanadium (V), rhodium (Rh), technetium (Tc), hafnium (Hf), ruthenium (Ru), boron (B), iridium (Ir), niobium (Nb), molybdenum (Mo), tantalum (Ta), osmium (Os), rhenium (Re), and tungsten (W).

The supporting belt 30 that satisfies the condition of Equation 1 may also be formed of a material that includes carbon, such as, carbon nanotubes, which can withstand a high temperature, or a silicon material.

The supporting belt 30 may be formed to have, for example, a caterpillar type.

In the current exemplary embodiment, the catalyst metal layer 401 formed of Cu or Ni is described. However, the material for forming the catalyst metal layer 401 is not limited thereto. For example, the catalyst metal layer 401 may also be formed of at least one of cobalt (Co), iron (Fe), platinum (Pt), gold (Au), aluminum (Al), Cr, magnesium (Mg), manganese (Mn), Rh, silica (Si), and titanium (Ti).

In operation S120, a gaseous carbon source is injected into the chamber 100. Referring to FIG. 2, while injecting the gaseous carbon source into the chamber 100 through an inlet 110 formed on the chamber 100, carbon atoms are deposited onto the catalyst metal layer 401 by heat-treating the catalyst metal layer 401 using a heater 140.

The heater 140 increases the temperature of the chamber 100 enough to separate the carbon atoms from the gaseous carbon source and simultaneously increases the temperature of the catalyst metal layer 401. For example, the temperature of the chamber 100 is greater than approximately 1,000° C. Methane (CH₄) gas, which is the gaseous carbon source, decomposes into carbon atoms and hydrogen atoms through a heat treatment process performed at approximately 1,000° C., and the separated carbon atoms are deposited onto the catalyst metal layer 401. In this case, the chamber 100 may be maintained at a pressure in a range from about 10⁻³ to about 10⁻² torr.

In the current exemplary embodiment, methane is described as the gaseous carbon source. However, the gaseous carbon source is not limited thereto. For example, the gaseous carbon source may be at least one material that contains carbon, such as carbon dioxide, ethane, ethylene, ethanol, acetylene, propane, propylene, butane, butadiene, pentane, pentene, cycloropentadien, hexane, cyclohexane, benzene, or toluene.

In the current exemplary embodiment, the case where only the gaseous carbon source is injected into the chamber 100 is described. However, the inventive concept is not limited thereto. For example, a pretreatment may be performed with respect to a surface of the catalyst metal layer 401 prior to injecting the gaseous carbon source. The pretreatment process is performed to remove foreign materials present on the catalyst metal layer 401 by using a hydrogen gas. The hydrogen gas is supplied through an inlet hole 120 formed on the chamber 100.

Alternatively, the surface of the catalyst metal layer 401 may be washed using an acid/alkali solution before the catalyst metal layer 401 is transported to the chamber 100. In this way, defects that can occur during the synthesis of graphene in a subsequent process can be reduced.

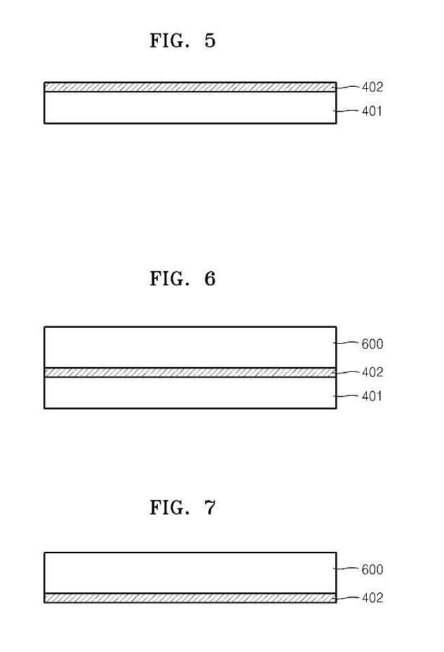

In operation S130, the graphene 402 is formed by cooling the catalyst metal layer 401. FIG. 5 is a schematic lateral cross-sectional view of the graphene 402 formed on a catalyst metal layer 401 according to operations S120 through S140 of FIG. 1. Carbon atoms deposited on the surface of the catalyst metal layer 401 are converted to the graphene 402 during cooling. The cooling may be performed in the same space, that is, in the chamber 100 where the temperature of the catalyst metal layer 401 is increased.

According to another exemplary embodiment, the cooling process may be performed in an additional cooling chamber (not shown) after taking out the catalyst metal layer 401 from the chamber 100. Alternatively, the catalyst metal layer 401 may be naturally cooled outside of the chamber 100 by taking out the catalyst metal layer 401 to the outside.

In operation S140, the catalyst metal layer 401 is conveyed to the outside of the chamber 100 by the supporting belt 30. That is, the supporting belt 30 is taken out to the outside from the chamber 100 after being used therein for the formation of the graphene 402 in operations S110 through S130.

When the supporting belt 30 and the catalyst metal layer 401 are taken out of the chamber 100, the catalyst metal layer 401 is separated from the supporting belt 30 by a reel 20 and a roller 35.

As depicted in the graph of FIG. 3, the mechanical strength of the catalyst metal layer 401 is significantly reduced in the high temperature chamber 100, and thus, the catalyst metal layer 401 is weakened due to its self-weight. However, since the catalyst metal layer 401 is supported by the supporting belt 30, tension generated by the reels 10 and 20 and the self-weight of the catalyst metal layer 401 may not affect the catalyst metal layer 401.

As depicted in FIG. 2, the supporting belt 30 has a circulating structure. That is, after the supporting belt 30 is used in the process of conveying the catalyst metal layer 401 into the chamber 100 and taking it out of the chamber 100, the supporting belt 30 performs a new role for conveying the catalyst metal layer 401 into the chamber 100. The process system of FIG. 2 includes rollers 31, 33, 34, 35, 36, and 37 for circulating the supporting belt 30.

In operation S150, a graphene protection film 600 is formed on the graphene 402. Referring to FIG. 2, when the catalyst metal layer 401 on which the graphene 402 is formed and the graphene protection film 600 are supplied to a protection film forming apparatus 200, the graphene protection film 600 is formed on the graphene 402 while passing through the protection film forming apparatus 200. FIG. 6 is a schematic lateral cross-sectional view of the graphene protection film 600 formed according to operation S150 of FIG. 1. The process system of FIG. 2 includes a reel 60, rollers 61, 62 and 41 for supplying the graphene protection film 600.

The graphene protection film 600 may be formed of a material such as a thermal exfoliation tape, a photoresist, an aqueous polyurethane resin, an aqueous epoxy resin, an aqueous acryl resin, an aqueous natural polymer resin, a water based adhesive, an alcohol exfoliation tape, acetic acid vinyl emersion adhesive, a hot-melt adhesive, a visible light hardening adhesive, an infrared ray hardening adhesive, an ultraviolet ray hardening adhesive, an electron beam hardening adhesive, a polybenzimidazole (PBI) adhesive, a polyimide adhesive, a silicon adhesive, an imide adhesive, a bismaleimide (BMI) adhesive, or a modified epoxy resin.

In operation S160, the catalyst metal layer 401 is removed. For example, the catalyst metal layer 401 may be removed by an etching process. Referring to FIG. 2, the catalyst metal layer 401 is conveyed to an etching space 300 using rollers 21, 22, 42 and 43 after the graphene protection film 600 is formed in operation S140. The etching space 300 includes a sprayer 310 that sprays an etching solution. The etching solution may be an acid, HF, a buffered oxide etch (BOE) solution, a FeCl₃ solution, or a Fe(No₃)₃ solution.

FIG. 7 is a schematic lateral cross-sectional view of the graphene 402 from which the catalyst metal layer 401 is removed according to operation S160 of FIG. 1.

The graphene 402 from which the catalyst metal layer 401 is removed is collected in a reel 50 after passing through rollers 51 and 52.

As described above, the case where the catalyst metal layer 401 according to the exemplary embodiment is conveyed into the chamber 100 by a reel-to-reel method is described. However, the inventive concept is not limited thereto. That is, besides the reel-to-reel method, if, in order to form a large area graphene, the catalyst metal layer 401 having a large area is conveyed into the chamber 100, and the mechanical strength of the catalyst metal layer 401 is reduced due to the high temperature of the chamber 100, deformation of the catalyst metal layer 401 in the high temperature chamber 100 may be prevented or minimized by using the supporting belt 30 according to the exemplary embodiment. For example, in the process of increasing the temperature of the catalyst metal layer 401, the surface or texture of the catalyst metal layer 401 may become non-uniform due to an internal constituent material or stress, and thus, the quality of the graphene may be degraded. However, in the exemplary embodiment, since the catalyst metal layer 401 is supported by the supporting belt 30, the catalyst metal layer 401 may maintain a stable shape even if the temperature of the catalyst metal layer 401 is increased.

For example, the catalyst metal layer 401 having a rectangular shape and a large area may be conveyed by the supporting belt 30 by being supported only at edges of the catalyst metal layer 401. When the catalyst metal layer 401 is exposed to a high temperature in a state in which only the edges of the catalyst metal layer 401 are supported, the mechanical strength of the catalyst metal layer 401 is greatly reduced, and, as a result, the catalyst metal layer 401 having a large area weakened due to its self-weight. However, when the supporting belt 30 supports the entire catalyst metal layer 401, deformation of the catalyst metal layer 401 and quality degradation of the graphene 402 due to the self-weight of the catalyst metal layer 401 may be prevented.

While the exemplary embodiments have been particularly shown and described with reference to the corresponding drawings, it will be understood by those of ordinary skill in the art that various changes in form and details may be made therein without departing from the spirit and scope of the inventive concept as defined by the following claims.

What is claimed is:

1. A method of manufacturing graphene, the method comprising:
placing a supporting belt, on which a catalyst layer is loaded, into a chamber;
increasing a temperature of the catalyst layer and injecting a carbon source into the chamber;
forming graphene on the catalyst layer by cooling the catalyst layer; and
taking out the supporting belt, on which the catalyst layer, on which the graphene is formed, is loaded, from the chamber to an outside.

2. The method of claim 1, wherein a ratio of a melting point of the supporting belt to a maximum temperature of the catalyst layer that the catalyst layer is heated in the chamber is equal to or less than 0.6.

3. The method of claim 1, wherein the supporting belt comprises at least one of zirconium (Zr), chromium (Cr), vanadium (V), rhodium (Rh), technetium (Tc), hafnium (Hf), ruthenium (Ru), boron (B), iridium (Ir), niobium (Nb), molybdenum (Mo), tantalum (Ta), osmium (Os), rhenium (Re), and tungsten (W).

4. The method of claim 1, wherein the placing the supporting belt, on which the catalyst layer is loaded, into the chamber comprises:
conveying a portion of the supporting belt, on which a portion of the catalyst layer is loaded, into the chamber;
separating the portion of the supporting belt from the portion of the catalyst layer after taking out the portion of the supporting layer, on which the portion of the catalyst layer is loaded, from the chamber; and
conveying the portion of the supporting belt, on which another portion of the catalyst layer is loaded, into the chamber.

5. The method of claim 1, further comprising separating the supporting belt from the catalyst layer on which the graphene is formed.

6. The method of claim 1, further comprising removing the catalyst layer from the catalyst layer on which the graphene is formed after the forming the graphene.

7. The method of claim 6, wherein the removing the catalyst layer comprises removing the catalyst layer by etching the catalyst layer.

8. The method of claim 6, further comprising forming a graphene protection film on the graphene between the forming the graphene and the removing the catalyst layer.

9. The method of claim 1, wherein the chamber is maintained at a pressure in a range from 10⁻³ to 10⁻² torr.

10. The method of claim 1, further comprising:
forming a graphene protection film on the graphene that is taken out of the chamber by the supporting belt; and
removing the catalyst metal layer by etching.

11. The method of claim 10, wherein a ratio of a melting point of the supporting belt to a maximum temperature of the catalyst layer that the catalyst layer is heated in the chamber is equal to or less than 0.6.

12. The method of claim 10, wherein the placing the supporting belt, on which the catalyst layer is loaded, into the chamber comprises:
conveying a portion of the supporting belt, on which a portion of the catalyst layer is loaded, into the chamber;
separating the portion of the supporting belt from the portion of the catalyst layer after taking out the portion of the supporting layer, on which the portion of the catalyst layer is loaded, from the chamber; and
conveying the portion of the supporting belt, on which another portion of the catalyst layer is loaded, into the chamber.

13. The method of claim 10, wherein the supporting belt comprises at least one of zirconium (Zr), chromium (Cr), vanadium (V), rhodium (Rh), technetium (Tc), hafnium (Hf), ruthenium (Ru), boron (B), iridium (Ir), niobium (Nb), molybdenum (Mo), tantalum (Ta), osmium (Os), rhenium (Re), and tungsten (W).

14. The method of claim 10, wherein the chamber is maintained at a pressure in a range from 10⁻³ to 10⁻² torr.

15. An apparatus for manufacturing graphene, the apparatus comprising:
a supporting belt provider which a catalyst layer on a supporting belt and provides the supporting belt on which the catalyst layer is loaded; and
a chamber which receives the supporting belt, on which the catalyst layer is loaded, provided from the supporting belt, increases a temperature of the catalyst layer while receiving a carbon source from an outside, forms graphene on the catalyst layer by cooling the catalyst layer, and outputs the supporting belt on which the catalyst layer, on which the graphene is formed, is loaded.

16. The apparatus of claim 15, wherein a ratio of a melting point of the supporting belt to a maximum temperature of the catalyst layer that the catalyst layer is heated in the chamber is equal to or less than 0.6.

17. The apparatus of claim 15, wherein the supporting belt comprises at least one of zirconium (Zr), chromium (Cr), vanadium (V), rhodium (Rh), technetium (Tc), hafnium (Hf), ruthenium (Ru), boron (B), iridium (Ir), niobium (Nb), molybdenum (Mo), tantalum (Ta), osmium (Os), rhenium (Re), and tungsten (W).

18. The apparatus of claim 15, wherein, in providing the supporting belt on which the catalyst layer is loaded to the chamber, the supporting belt provider:
conveys a portion of the supporting belt, on which a portion of the catalyst layer is loaded, into the chamber;
separates the portion of the supporting belt from the portion of the catalyst layer after taking out the portion of the supporting layer, on which the portion of the catalyst layer is loaded, from the chamber; and
conveys the portion of the supporting belt, on which another portion of the catalyst layer is loaded, into the chamber.

19. The apparatus of claim 15, the supporting belt provider further separates the supporting belt from the catalyst layer on which the graphene is formed.

20. The apparatus of claim 15, the chamber is maintained at a pressure in a range from 10⁻³ to 10⁻² torr.
